(19) United States
(12) Patent Application Publication
(10) Pub. No.: US 2018/0107061 A1
(43) Pub. Date: Apr. 19, 2018

(54) REFLECTIVE LIQUID CRYSTAL DISPLAY PANEL

(71) Applicants: SHENZEN CHINA STAR OPTOELECTRONICS TECHNOLOGY CO., LTD., Guangdong (CN); WUHAN CHINA STAR OPTOELECTRONICS TECHNOLOGY CO., LTD., Hubei (CN)

(72) Inventor: Xinhui Zhong, Guangdong (CN)

(21) Appl. No.: 15/114,606

(22) PCT Filed: Apr. 8, 2016
(86) PCT No.: PCT/CN2016/078766

§ 371 Date: Jul. 27, 2016

(30) Foreign Application Priority Data
Mar. 11, 2016 (CN) 201610139329.5

(51) Int. Cl. G02F 1/1335; G02F 1/1343

(52) U.S. Cl. CPC G02F 1/133553; G02F 1/134309; G02F 1/13439; G02F 1/13394; G02F 2203/02; G02F 2201/121; G02F 2201/123; G02F 1/133512

(57) ABSTRACT

A reflective liquid crystal display panel is provided, and includes: an upper substrate, a bottom substrate, and a liquid crystal layer disposed between the upper substrate and the bottom substrate. The upper substrate includes a common electrode used for providing a common voltage. The bottom substrate includes a pixel electrode used for providing a driving voltage, and a color reflecting layer used for reflecting ambient light from an exterior.

### FIELD OF THE INVENTION

The present invention relates to the field of liquid crystal displays, and more particularly to a reflective liquid crystal display panel.

### BACKGROUND OF THE INVENTION

With the rise of products and applications of wearable devices (such as smartwatches, smart glasses, and so on), in a case that the amount of electricity in a battery is limited, battery life in a display device is influenced by an energy consumption issue, so the development of display device with low energy consumption and high performance becomes more and more important.

Reflective liquid crystal display panels are applied in wearable devices. The reflective liquid crystal display panel can reflect ambient light as a paper for displaying, so a backlight source having high energy consumption is omitted. In comparison to conventional active liquid crystal display panels, 80% of the energy can be saved, so that the battery life in the device can be significantly extended, thereby improving user experience.

Please refer to FIG. 1, which is a structural schematic diagram of a conventional reflective liquid crystal display panel, where the reference numeral 11 represents an upper substrate base, the reference numeral 12 represents a color resist film, the reference numeral 13 represents a common electrode, the reference numeral 14 represents a liquid crystal layer, the reference numeral 15 represents a metal reflecting electrode, and the reference numeral 16 represents a bottom substrate base. The color resist film 12 comprises three color resists of three different colors, i.e., red, green, and blue (RGB). Different color resists have different transmission spectrums. The red color resist allows light in a red wavelength range to pass and absorbs light in a non-red wavelength range. The blue color resist allows light in a blue wavelength range to pass and absorbs light in a non-blue wavelength range. The green color resist allows light in a green wavelength range to pass and absorbs light in a non-green wavelength range.

In use of the conventional reflective liquid crystal display panel, due to the reflective liquid crystal display panel being used for reflecting ambient light from an exterior, after the ambient light from the exterior passes the color resist film 12 into the liquid crystal layer 14, it will be reflected by the metal reflecting electrode 15 so as to return and pass the color resist film 12 and then to the outside environment. The ambient light from the exterior will pass twice through the color resist film 12, and the light will be absorbed twice by the color resist film 12. Thus, the reflective liquid crystal display panel will have problems such as low light reflectivity and poor color mixture.

Accordingly, it is necessary to provide a reflective liquid crystal display panel to solve the technical problem in the prior art.

### SUMMARY OF THE INVENTION

The present invention provides a reflective liquid crystal display panel having high light reflectivity and excellent color display effect in display images, so as to solve the technical problems of low light reflectivity and poor color mixture in the conventional reflective liquid crystal display panel.

The present invention provides a reflective liquid crystal display panel, comprising: an upper substrate, a bottom substrate, and a liquid crystal layer disposed between the upper substrate and the bottom substrate;

wherein the upper substrate comprises:

an upper substrate base;

a common electrode disposed on an inner side of the upper substrate base, for providing a common voltage;

the bottom substrate comprises:

a bottom substrate base;

a pixel electrode disposed on an inner side of the bottom substrate base, for providing a driving voltage; and

a color reflecting layer disposed on an inner side of the pixel electrode, for reflecting ambient light from an exterior;

wherein the color reflecting layer is non-transparent and has a high-reflectivity layer with a characteristic of reflecting light with a selected wavelength; there is a photo spacer disposed on an inner surface of the upper substrate or the bottom substrate.

In the reflective liquid crystal display panel of the present invention, the pixel electrode is a transparent metal electrode.

In the reflective liquid crystal display panel of the present invention, the pixel electrode is a non-transparent metal electrode.

In the reflective liquid crystal display panel of the present invention, the color reflecting layer comprises a red reflecting layer, a blue reflecting layer, and a green reflecting layer; there is a black matrix disposed between reflecting layers of different colors.

The present invention also provides a reflective liquid crystal display panel, comprising: an upper substrate, a bottom substrate, and a liquid crystal layer disposed between the upper substrate and the bottom substrate;

wherein the upper substrate comprises:

an upper substrate base;

a common electrode disposed on an inner side of the upper substrate base, for providing a common voltage;

the bottom substrate comprises:

a bottom substrate base;

a pixel electrode disposed on an inner side of the bottom substrate base, for providing a driving voltage; and

a color reflecting layer disposed on an inner side of the pixel electrode, for reflecting ambient light from an exterior.

In the reflective liquid crystal display panel of the present invention, the color reflecting layer is non-transparent and has a high-reflectivity layer with a characteristic of reflecting light with a selected wavelength.

In the reflective liquid crystal display panel of the present invention, the pixel electrode is a transparent metal electrode.

In the reflective liquid crystal display panel of the present invention, the pixel electrode is a non-transparent metal electrode.

In the reflective liquid crystal display panel of the present invention, the color reflecting layer comprises a red reflecting layer, a blue reflecting layer, and a green reflecting layer; there is a black matrix disposed between reflecting layers of different colors.

In the reflective liquid crystal display panel of the present invention, there is a photo spacer disposed on an inner surface of the upper substrate or the bottom substrate.

The present invention also provides reflective liquid crystal display panel, comprising: an upper substrate, a bottom substrate, and a liquid crystal layer disposed between the upper substrate and the bottom substrate;

wherein the upper substrate comprises:

an upper substrate base;

a common electrode disposed on an inner side of the upper substrate base, for providing a common voltage;

the bottom substrate comprises:

a bottom substrate base;

a color reflecting layer disposed on an inner side of the pixel electrode, for reflecting ambient light from an exterior; and

a pixel electrode disposed on an inner side of the bottom substrate base, for providing a driving voltage.

In the reflective liquid crystal display panel of the present invention, the color reflecting layer is non-transparent and has a high-reflectivity layer with a characteristic of reflecting light with a selected wavelength.

In the reflective liquid crystal display panel of the present invention, the pixel electrode is a transparent metal electrode.

In the reflective liquid crystal display panel of the present invention, the color reflecting layer comprises a red reflecting layer, a blue reflecting layer, and a green reflecting layer; there is a black matrix disposed between reflecting layers of different colors.

In the reflective liquid crystal display panel of the present invention, there is a photo spacer disposed on an inner surface of the upper substrate or the bottom substrate.

In the reflective liquid crystal display panel of the present invention, by disposing the color reflecting layer on the bottom substrate, the ambient light from the exterior is transmitted to the outside after being reflected only once by the color reflecting layer, thereby decreasing the loss of the ambient light on color resist film, and increasing the light reflectivity of the reflective liquid crystal display panel, and improving the color image display effect of the reflective liquid crystal display panel, so as to solve the technical problems that low light reflectivity and poor color mixture in the conventional reflective liquid crystal display panel.

### BRIEF DESCRIPTION OF THE DRAWINGS

In order to illustrate the technical solutions in the embodiments of the present invention or in the prior art more clearly, the following briefly introduces the accompanying drawings required for describing the embodiments or the prior art. The accompanying drawings in the following description are merely some embodiments of the present invention, and persons of ordinary skill in the art may still derive other drawings from these accompanying drawings without creative effort.

FIG. 1 is a structural schematic diagram of a conventional reflective liquid crystal display panel.

FIG. 2 is a structural schematic diagram of a reflective liquid crystal display panel of a first preferred embodiment of the present invention.

FIG. 3 is a structural schematic diagram of a reflective liquid crystal display panel of a second preferred embodiment of the present invention.

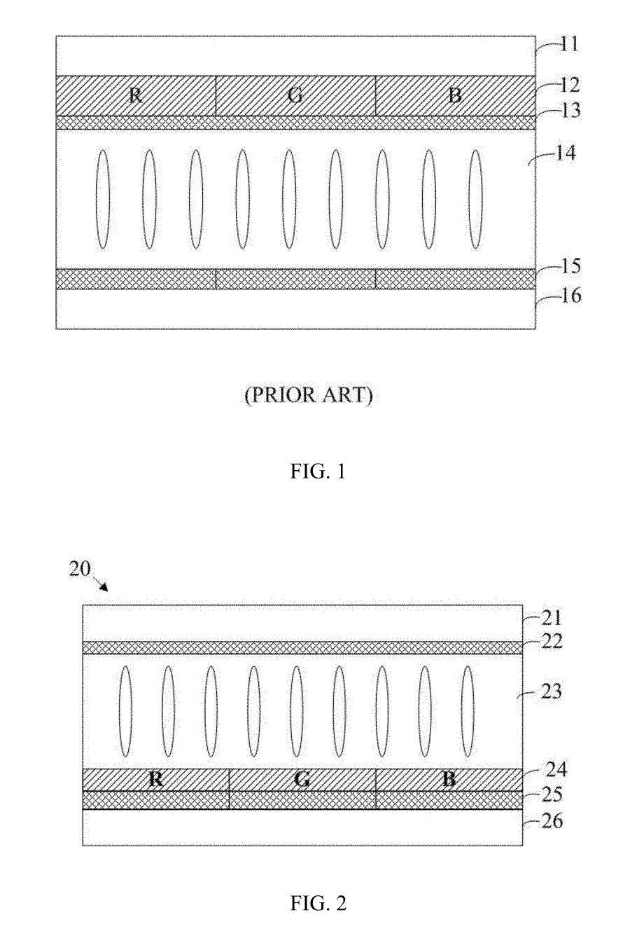

### DETAILED DESCRIPTION OF THE INVENTION

Please refer to the accompanying drawings, similar parts are denoted with the same reference numerals. The following description is based on the particular embodiments of the present invention, and they should not be construed as limiting the invention to the other embodiments which are not discussed in detail herein.

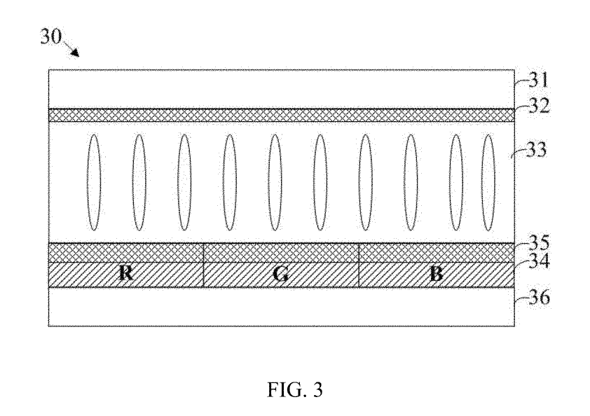

Please refer to FIG. 2, which is a structural schematic diagram of a reflective liquid crystal display panel of a first preferred embodiment of the present invention. In this preferred embodiment, the reflective liquid crystal display panel 20 comprises an upper substrate, a bottom substrate, and a liquid crystal layer 23 disposed between the upper substrate and the bottom substrate.

The upper substrate comprises an upper substrate base 21 and a common electrode 22. The common electrode 22 is disposed on an inner side of the upper substrate base 21, for providing a common voltage. The common electrode 22 is a transparent metal electrode, such as Indium Tin Oxide (ITO), etc.

The bottom substrate comprises a bottom substrate base 26, a pixel electrode 25, and a color reflecting layer 24. The pixel electrode 25 is disposed on an inner side of the bottom substrate base 26, for providing a driving voltage. The color reflecting layer 24 is located upon the pixel electrode 25, for reflecting ambient light from the exterior.

The color reflecting layer 24 is non-transparent and has a high-reflectivity with a characteristic of reflecting light with a selected wavelength. Specifically, the color reflecting layer 24 comprises a red reflecting layer, a blue reflecting layer, and a green reflecting layer. The red reflecting layer has high reflectivity at the red light wavelength. The blue reflecting layer has high reflectivity at the blue light wavelength. The green reflecting layer has high reflectivity at the green light wavelength. There is a black matrix (not shown in the Figs.) disposed between color reflecting layers 24 of different colors, which is used for absorbing light in all wavelength bands, so as to prevent a crosstalk phenomenon appearing at edges of the respective monochromatic color reflecting layers.

The pixel electrode 25 may be a transparent metal electrode or a non-transparent metal electrode. Since the reflected light of the color reflecting layer 24 serves as a light source, the pixel electrode 25 located under the color reflecting layer 24 may be the non-transparent metal electrode, so as to reduce the manufacture cost of the pixel electrode 25. It should be understood that the transparent metal electrode (such as Indium Tin Oxide (ITO)) may be adopted based on the user's requirement.

In use of the reflective liquid crystal display panel 20 of the present preferred embodiment, a drive circuit applies a driving voltage to the pixel electrode 25 and applies a common voltage to the common electrode 22. The liquid crystal molecules in the liquid crystal layer 23 are deflected under the action of the driving voltage and the common voltage, so that linearly polarized light passes through the liquid crystal layer 23. Therefore, the ambient light from the exterior sequentially passes through the upper substrate base 21, the common electrode 22, and the liquid crystal layer 23 to arrive the color reflecting layer 24, and then it is reflected by the color reflecting layer 24.

Since red light is reflected by only the red reflecting layer, blue light is reflected by only the blue reflecting layer, green light is reflected by only the green reflecting layer, the ambient light from the exterior will form three emitting light beams, red, blue, and green, after being reflected by the color reflecting layer 24. The three emitting light beams sequentially pass the liquid crystal layer 23, the common electrode 22, and the upper substrate base 21 and then to the outside environment. Therefore, the image display process of red, green, and blue pixel units is accomplished.

In the image display process of the reflective liquid crystal display panel 20 of the present preferred embodiment, since there is no color resist film to be disposed on the upper substrate, the ambient light from the exterior will not be absorbed twice by the color resist film, and it will be absorbed and reflected once by the color reflecting layer 24. Accordingly, the reflective liquid crystal display panel 20 has high light reflectivity, and the poor color mixture problem will not appear.

Preferably, in the reflective liquid crystal display panel 20 of the present preferred embodiment, there is a photo spacer (PS) disposed on an inner surface of the upper substrate or the bottom substrate, so that a distance between the upper substrate and the bottom substrate of the liquid crystal layer display panel 20 is maintained.

In the reflective liquid crystal display panel 20 of the present preferred embodiment, by disposing the color reflecting layer 24 on the bottom substrate, the ambient light from the exterior is transmitted to the outside after being reflected only once by the color reflecting layer 24, thereby decreasing the loss of the ambient light on color resist film, and increasing the light reflectivity of the reflective liquid crystal display panel, and improving the color image display effect of the reflective liquid crystal display panel.

Please refer to FIG. 3, which is a structural schematic diagram of a reflective liquid crystal display panel of a second preferred embodiment of the present invention. In this preferred embodiment, the reflective liquid crystal display panel 30 comprises an upper substrate, a bottom substrate, and a liquid crystal layer 33 disposed between the upper substrate and the bottom substrate.

The upper substrate comprises an upper substrate base 31 and a common electrode 32. The common electrode 32 is used for providing a common voltage. The common electrode 32 is a transparent metal electrode, such as indiums Tin Oxide (ITO), etc.

The bottom substrate comprises a bottom substrate base 36, a pixel electrode 35, and a color reflecting layer 34. The color reflecting layer 34 is disposed on an inner side of the bottom substrate base 36, for reflecting the ambient light from the exterior. The pixel electrode 35 is disposed on the color reflecting layer 34, for providing a driving voltage.

The color reflecting layer 34 is non-transparent and has a high-reflectivity layer with a characteristic of reelecting light with a selected wavelength. Specifically, the color reflecting layer 34 comprises a red reflecting layer, a blue reflecting layer, and a green reflecting layer. The red reflecting layer has high reflectivity at the red light wavelength. The blue reflecting layer has high reflectivity at the blue light wavelength. The green reflecting layer has high reflectivity at the green light wavelength. There is a black matrix (not shown in the Figs.) disposed between different color reflecting layers, which is used for absorbing light in all wavelength bands, so as to prevent a crosstalk phenomenon appearing at edges of the respective monochromatic color reflecting layers.

The pixel electrode 35 may be a transparent metal electrode, such as Indium Tin Oxide (ITO). The pixel electrode 35 is disposed on the color reflecting layer 34, so it may be helpful to reduce an electrode gap, to increase a liquid crystal capacitance, and to decrease the driving voltage.

In use of the reflective liquid crystal display panel 30 of the present preferred embodiment, a drive circuit applies a driving voltage to the pixel electrode 35 and applies a common voltage to the common electrode 32. The liquid crystal molecules in the liquid crystal layer 33 are deflected under the action of the driving voltage and the common voltage, so that linearly polarized light passes through the liquid crystal layer 33. Therefore, the ambient light from the exterior sequentially passes through the upper substrate base 31, the common electrode 32, and the liquid crystal layer 33 to arrive the color reflecting layer 34, and then it is reflected by the color reflecting layer 34.

Since red light is reflected by only the red reflecting layer, blue light is reflected by only the blue reflecting layer, green light is reflected by only the green reflecting layer, the ambient light from the exterior will form three emitting light beams, red, blue, and green, after being reflected by the color reflecting layer 34. The three emitting light beams sequentially pass the pixel electrode 35, the liquid crystal layer 33, the common electrode 32, and the upper substrate base 31 and then to the outside environment. Therefore, the image display process of red, green, and blue pixel units is accomplished.

In the image display process of the reflective liquid crystal display panel 30 of the present preferred embodiment, since there is no color resist film to be disposed on the upper substrate, the ambient light from the exterior will not be absorbed twice by the color resist film, and it will be absorbed and reflected only once by the color reflecting layer 34. Accordingly, the reflective liquid crystal display panel 30 has high light reflectivity, and the poor color mixture problem will not appear.

Preferably, in the reflective liquid crystal display panel 30 of the present preferred embodiment, there is a photo spacer disposed on an inner surface of the upper substrate or the bottom substrate, so that a distance between the upper substrate and the bottom substrate is maintained.

In comparison with the first preferred embodiment, the pixel electrode of the reflective liquid crystal display panel of the present preferred embodiment is disposed on the color reflecting layer, so it may be helpful to reduce the electrode gap, to increase the liquid crystal capacitance, and to decrease the driving voltage, thereby increasing the image display quality.

In the reflective liquid crystal display panel of the present invention, by disposing the color reflecting layer on the bottom substrate, the ambient light from the exterior is transmitted to the outside after being reflected only once by the color reflecting layer, thereby decreasing the loss of the ambient light on the color resist film, and increasing the light reflectivity of the reflective liquid crystal display panel, and improving the color image display effect of the reflective liquid crystal display panel, so as to solve the technical problems that low light reflectivity and poor color mixture in the conventional reflective liquid crystal display panel.

In summary, the above descriptions are merely preferable embodiments of the present invention, hut are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A reflective liquid crystal display panel, comprising: an upper substrate, a bottom substrate, and a liquid crystal layer disposed between the upper substrate arid the bottom substrate;
wherein the upper substrate comprises:
an upper substrate base;
a common electrode disposed on an inner side of the upper substrate base, for providing a common voltage;
the bottom substrate comprises:
a bottom substrate base;
a pixel electrode disposed on an inner side of the bottom substrate base, for providing a driving voltage; and
a color reflecting layer disposed on an inner side of the pixel electrode, for reflecting ambient light from an exterior;
wherein the color reflecting layer is non-transparent and has a high-reflectivity layer with a characteristic of reflecting light with a selected wavelength; there is a photo spacer disposed on an inner surface of the upper substrate or the bottom substrate.

2. The reflective liquid crystal display panel claimed in claim 1, wherein the pixel electrode is a transparent metal electrode.

3. The reflective liquid crystal display panel as claimed in claim 1, wherein the pixel electrode is a non-transparent metal electrode.

4. The reflective liquid crystal display panel as claimed in claim 1, wherein the color reflecting layer comprises a red reflecting layer, a blue reflecting layer, and a green reflecting layer; there is a black matrix disposed between reflecting layers of different colors.

5. A reflective liquid crystal display panel, comprising: an upper substrate, a bottom substrate, and a liquid crystal layer disposed between the upper substrate and the bottom substrate;
wherein the upper substrate comprises:
an upper substrate base;
a common electrode disposed on an inner side of the upper substrate base, for providing a common voltage;
the bottom substrate comprises:
a bottom substrate base;
a pixel electrode disposed on an inner side of the bottom substrate base, for providing a driving voltage; and
a color reflecting layer disposed on an inner side of the pixel electrode, for reflecting ambient light from an exterior.

6. The reflective liquid crystal display panel as claimed in claim 5, wherein the color reflecting layer is non-transparent and has a high-reflectivity layer with a characteristic of reflecting light with a selected wavelength.

7. The reflective liquid crystal display panel as claimed in claim 5, wherein the pixel electrode is a transparent metal electrode.

8. The reflective liquid crystal display panel as claimed in claim 5, wherein the pixel electrode is a non-transparent metal electrode.

9. The reflective liquid crystal display panel as claimed in claim 5, wherein the color reflecting layer comprises a red reflecting layer, a blue reflecting layer, and a green reflecting layer; there is a black matrix disposed between reflecting layers of different colors.

10. The reflective liquid crystal display panel as claimed in claim 5, wherein there is a photo spacer disposed on an inner surface of the upper substrate or the bottom substrate.

11. A reflective liquid crystal display panel, comprising: an upper substrate, a bottom substrate, and a liquid crystal layer disposed between the upper substrate and the bottom substrate;
wherein the upper substrate comprises:
an upper substrate base;
a common electrode disposed on an inner side of the upper substrate base, for providing a common voltage;
the bottom substrate comprises:
a bottom substrate base;
a color reflecting layer disposed on an inner side of the pixel electrode, for reflecting ambient light from an exterior; and
a pixel electrode disposed on an inner side of the bottom substrate base, for providing a driving voltage.

12. The reflective liquid crystal display panel as claimed in claim 11, wherein the color reflecting layer is non-transparent and has a high-reflectivity layer with a characteristic of reflecting light with a selected wavelength.

13. The reflective liquid crystal display panel as claimed in claim 11, wherein the pixel electrode is a transparent metal electrode.

14. The reflective liquid crystal display panel as claimed in claim 11, wherein the color reflecting layer comprises a red reflecting layer, a blue reflecting layer, and a green reflecting layer; there is a black matrix disposed between reflecting layers of different colors.

15. The reflective liquid crystal display panel as claimed in claim 11, wherein there is a photo spacer disposed on an inner surface of the upper substrate or the bottom substrate.
